(19) United States
(12) Patent Application Publication
(10) Pub. No.: US 2025/0261698 A1
(43) Pub. Date: Aug. 21, 2025

(54) BIOMETRIC INTERLOCK FOR PERSONAL VAPORIZER

(71) Applicant: Kyle D. Newton, Euless, TX (US)

(72) Inventor: Kyle D. Newton, Euless, TX (US)

(21) Appl. No.: 18/583,464

(22) Filed: Feb. 21, 2024

(51) Int. Cl. A24F 40/53; A24F 40/10; A24F 40/51; A24F 40/57; A24F 40/60; A24F 40/65; G06V 40/10

(52) U.S. Cl. CPC A24F 40/53; A24F 40/10; A24F 40/51; A24F 40/57; A24F 40/60; A24F 40/65; G06V 40/10

(57) ABSTRACT

The present disclosure describes systems, methods, and an apparatus for controlling access to a personal vaporizer. The system can include a personal vaporizer that includes a reservoir configured to hold a fluid to be vaporized, a puff sensor configured to detect airflow through the personal vaporizer and generate a puff signal, a heating element configured to atomize the fluid to be vaporized, and a first controller configured to receive the puff signal and deliver power to the heating element in response. The system can further include a biometric interlock that includes a biometric sensor configured to detect a lip print of a user, and a second controller configured to receive the lip print from the biometric sensor and determine that the lip print is an authorized lip print and in response enable the first controller to deliver power to the heating element.

### BACKGROUND

Personal vaporizers provide an alternative to smoking techniques which involve combustion of organic matter and inhalation of the vapor. Instead, vaporizers atomize a substance (e.g., a nicotine substance or cannabis substance) using a heating element to simulate the combustion found in traditional cigarettes. Personal vaporizers often use removable/replaceable cartridges containing a substance for atomization. Different substances may require different heating profiles for improved vaporization.

### SUMMARY

The present disclosure involves systems, methods, and an apparatus for controlling access to a personal vaporizer. The system can include a personal vaporizer that includes a reservoir configured to hold a fluid to be vaporized, a puff sensor configured to detect airflow through the personal vaporizer and generate a puff signal, a heating element configured to atomize the fluid to be vaporized, and a first controller configured to receive the puff signal and deliver power to the heating element in response. The system can further include a biometric interlock that includes a biometric sensor configured to detect a lip print of a user, and a second controller configured to receive the lip print from the biometric sensor and determine that the lip print is an authorized lip print and in response enable the first controller to deliver power to the heating element.

Implementations optionally include one or more of the following features.

In some instances, the second controller is configured to prevent the first controller from delivering power in response to determining that the lip print is an unauthorized lip print.

In some instances, the biometric interlock includes one or more seals that direct airflow through the personal vaporizer.

In some instances, the biometric interlock includes a battery configured to supply power to the second controller and the biometric sensor.

In some instances, the biometric sensor is an optical sensor.

In some instances, the biometric interlock includes a communication link with the personal vaporizer, and the second controller enables the first controller by sending a signal through the communication link.

In some instances, the biometric interlock includes a heater button that is configured to send a signal to the first controller using the communication link.

In some instances, the biometric interlock includes a program button that, when depressed, causes the second controller to record a lip print from the biometric sensor as the authorized lip print.

Implementations can further include a method for activating a personal vaporizer including sensing contact of a user on a lip sensor, scanning a lip print of the user with the lip sensor, and determining that the lip print is an authorized. In response to determining the lip print is authorized, a controller of the personal vaporizer is enabled to deliver power to a heating element of the personal vaporizer.

In some instances, the controller delivers power to the heating element in response to a puff signal generated by a puff sensor of the personal vaporizer.

In some instances, when it is determined that the lip print is not the authorized lip print, or there is no lip print, the controller is prevented from delivering power to the heating element.

In some instances, sensing contact of a user is performed with a capacitive sensor of the lip sensor.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts a perspective view of an example implementation of a personal vaporizer.

FIG. 2 depicts a side view of an example personal vaporizer with a removable cartridge removed.

FIG. 3 illustrates a schematic diagram of some internal components of a personal vaporizer cartridge and power supply with an integrated biometric interlock.

FIG. 4 illustrates an example of personal vaporizer with detachable biometric interlock.

### DETAILED DESCRIPTION

This disclosure describes a system and method of controlling user access to a personal vaporizer such as an electronic cigarette, a vape pen, vape kits, e-cig, or e-hookah, electronic nicotine delivery system. In some personal vaporizer implementations, a power supply portion operates a disposable cartridge portion. The cartridge includes a reservoir containing the substance to be vaporized, and a heating element. However, certain substances may be strictly regulated by governing authorities or otherwise be dangerous if consumed in too great a quantity. This disclosure describes a system and techniques for enhancing security of a personal vaporizer to ensure only authorized user have access by incorporating a biometric interlock that record a lip print of the user when they place their mouth on the personal vaporizer.

A biometric lip sensor can activate the device when the user places it in their mouth to take a drag or draw air through the personal vaporizer. Each individual has a unique lip print, similar to a fingerprint, that can be used to identify that individual. By requiring a positive lip print match, it becomes very difficult for an unauthorized person to use the personal vaporizer. Unlike a fingerprint sensor, or other biometric sensor, it is impractical for a person to use the lip sensor unless they're using the device. That is, to activate the device, the lip sensor, and thus device, must be placed into the user's mouth. This enhances security as an authorized user is not practically able to activate the device for an unauthorized user. For example, in a fingerprint implementation, an authorized user could hold the device while an unauthorized user inhales.

The biometric lip sensor can be incorporated into the cartridge, or can be a separate interlock component that fits over the cartridge. In implementations where the cartridge is refillable and reusable, an integrated biometric sensor may be preferred to minimize the overall number of separate components. In implementations where the cartridge is disposable, a separate biometric cap can fit over the disposable cartridge, and interface with the power supply independently of the cartridge.

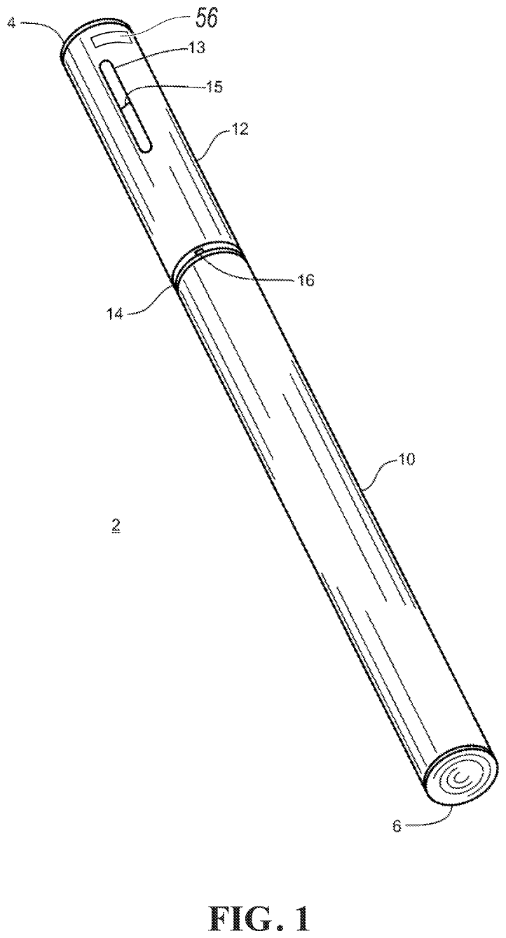

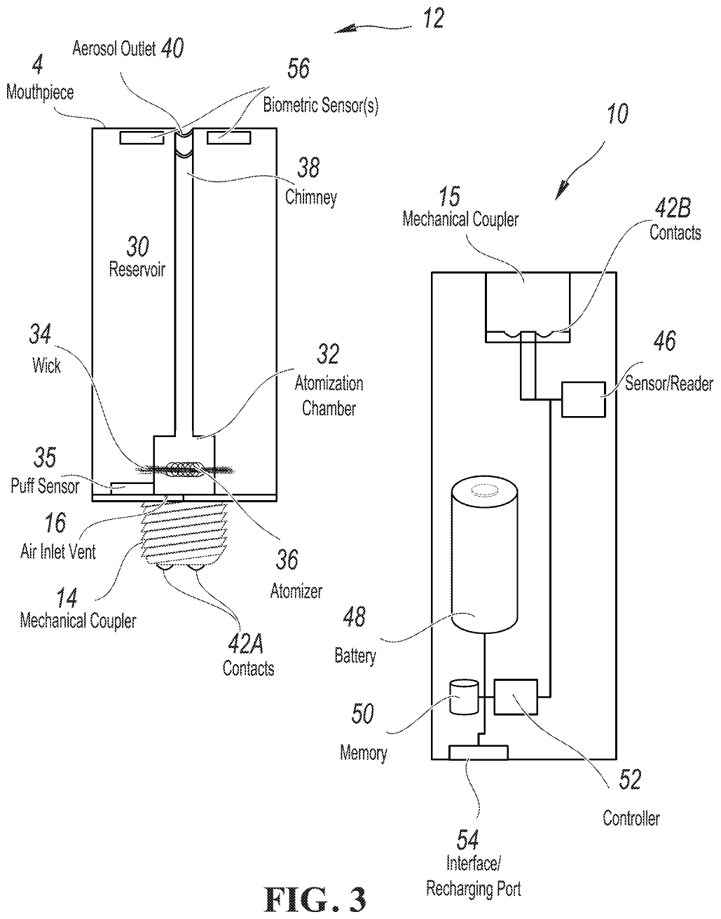

Turning to the illustrated example implementation, FIG. 1 is a perspective view of a personal vaporizer. While illustrated in the form factor of an electronic cigarette, the concepts herein could be applied to other types of personal vaporizers such as e-hookahs, vape kits, vape pens, etc. The example personal vaporizer 2 includes a housing having a first elongated portion 10 and a second elongated portion 12. The second elongated portion 12, also referred to as the “cartridge” in certain illustrative implementations, includes a mouthpiece end 4, which has an aerosol outlet (depicted in FIG. 3) for drawing air through the cartridge 12. The first elongated portion 10 and the second elongated portion 12 are removably joined together with a mechanical coupler 14. One or more air inlet vents 16 are provided about the coupler 14 for allowing airflow into the cartridge 12 when the user draws air through the personal vaporizer 2. The first elongated portion 10 includes a tip end 6, which in the illustrative implementation, is fabricated from a translucent material enabling the transmission of light therethrough. Within the second elongated portion 12 is disposed a liquid reservoir (not fully shown). In some implementations, the liquid reservoir includes a clear or translucent window 13 to the exterior of the housing 12 for visually determining the liquid level 15 within the liquid reservoir.

In the illustrated example, a biometric sensor 56 is integrated into the housing of the cartridge 12, which can be used to obtain a scan of the lips of a user in order to enable the use of the personal vaporizer 2 by a particular person.

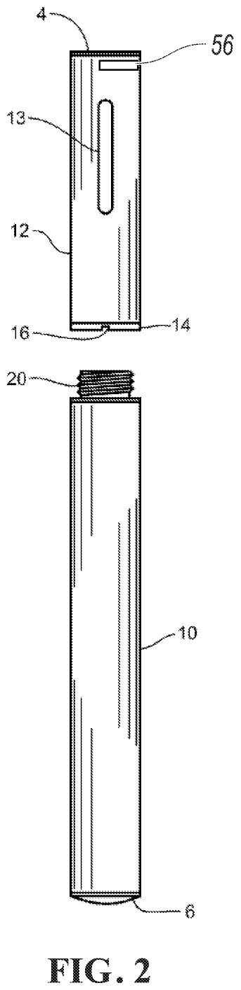

FIG. 2 depicts a side view drawing, respectively, of a cartridge portion 12 and a power supply portion 10 of a personal vaporizer 2 according to an illustrative embodiment of the present invention. The mechanical coupler 14 can have two parts, one that is part of the cartridge portion 12 and one that is part of the power supply portion 10, e.g., one part being female and configured to receive the other, male, part. The mechanical coupler can be, for example, threads, a lug/channel connector, a recessed magnetic connector or other suitable means for coupling the two portions of the personal vaporizer 2. FIG. 2 shows the mechanical coupling 14 portion on the power supply portion 10 in the form of a threaded extension 20 of the housing that engages female threads of the mechanical coupler 14 portion on the cartridge portion 12. In some implementations (as shown below and discussed with reference to in FIG. 3), the cartridge 12 can include a threaded or male portion, which engages with female threads of the power supply portion 10. In addition, an electrical connection can also be facilitated in the connection between the mechanical coupler 14 parts (as shown in more detail below with respect to FIG. 3). The power supply portion 10 can include one or more circuits for controlling operations of the cartridge portion 12. The circuits can be analog or digital and can include, for example, a microcontroller and various sensors to enable operation of the personal vaporizer 2. In this example illustration, the cartridge portion 12 can thus be installed, uninstalled, and replaced as needed. The cartridge portion contains the liquid reservoir and window 13 provides the visual indication as to the liquid remaining.

FIG. 3 illustrates a schematic diagram of some internal components of a personal vaporizer cartridge 12 and power supply 10.

Cartridge 12 includes a reservoir 30 and an atomization chamber 32. The atomization chamber 32 receives a primary substance in liquid form from the reservoir 30 via the wick 34. The wick 34 can be a fibrous bundle that draws liquid via capillary action from the reservoir 30. The wick 34 extends from the primary reservoir into the atomization chamber 32. It can be formed of a heat-resistant wicking material, such as aramid, fluorocarbon, sulfide, melamine, polyimide, carbon, glass fibers, or any combination thereof. An atomizer 36 can be a resistive coil that generates heat when electrical current passes through it. The atomizer 36 can be supplied with electrical power from the power supply portion 10 of the personal vaporizer. The atomizer 36 is located proximal to the wick 34 (in the example illustrated in FIG. 3 it is wrapped around the wick 34). Atomizer 36 heats the liquid carried from the primary reservoir 38 by the wick 34 and atomizes the primary substance which mixes with air in the atomization chamber to form an aerosol. One or more air inlet vents 16 near the bottom of the cartridge 12 allow airflow from the air inlet vent 16, through the atomization chamber 32 and out the chimney 38.

Chimney 38 provides a flow path from the air inlet vent 16, through the atomization chamber 32, and out the aerosol outlet 40 in the mouthpiece 4 portion of the cartridge 12. Mechanical coupler 14, illustrated as a threaded nipple, can include one or more electrical contacts 42A, which are configured to mate with corresponding contacts 42B on the power supply 10. In some implementations, the mechanical coupler 14 can be another type of coupler (e.g., a snap fit, pin and groove, magnetic, etc.). These contacts 42A can provide an electrical flow path from the battery 48, via the controller 52, through the atomizer 36. In some implementations, contacts 42A are a simple two pin system, with a positive and a common connection. In some implementations, contacts 42A are more complex, and can include, for example, serial connections, dedicated transmit/receive connections, or other configurations. Cartridge 12 can include one or more puff sensors 35 which can be, for example, a microphone, or pressure sensor, that transmits a “puff” signal to the controller to enable the power supply 10 to activate the atomizer 36 when a user induces airflow through the cartridge 12. In some implementations, sensor data is transmitted from the cartridge 12 to the power supply 10 wirelessly, e.g., using Bluetooth Low Energy, or ZigBee. In some implementations, sensor data (e.g., temperature data, puff data, or other information) is transmitted via contacts 42A and 42B.

In addition to a pressure or puff sensor 35, one or more biometric sensors 56 can be included and integrated into the cartridge 12. The biometric sensor 56 can be similar to a fingerprint sensor but designed to detect ridges and valleys in the user's lips. The biometric sensor 56 can include various types of sensors including optical, capacitive, ultrasonic sensors, or a combination thereof. Optical sensors which emit electromagnetic energy through a prism onto the lips, then collect reflected energy in a detector such as a charged coupled device (CCD) or complementary metal oxide semiconductor (CMOS) sensor. Capacitive devices can include an array of sensor pixels that measure capacitance variances between the ridges and valleys of the lip prints in. Capacitive sensors can be passive sensors that measure the dielectric constant of the lips (and their ridges and valleys) or active capacitive sensors. Active capacitive sensors may generate time varying electric fields in order to observe impedance variances due to the lips of the user. In some implementations a combination of sensors is used, for example a capacitive array can be used to detect the presence of lips and activate an optical sensor, which records an image that is then correlated with the capacitive measurements to generate a three-dimensional structure of the lips.

Ultrasonic sensors can transmit high frequency sonic pulses toward the lips from a transducer. The sonic pulses reflect off the user's lips and are captured by a receiver or array of receivers, then a signal processing system identifies ridges and valleys in the lip based on changes to the reflected sonic pulses, such as doppler shift, and time delays.

Power supply 10 includes a complementary mechanical coupler 15 and complementary contacts 42B which can receive and couple to mechanical coupler 14 and contacts 42A, completing an electrical connection and enabling power transfer and communication between power supply 10 and cartridge 12. In some implementations, the mechanical coupler 15 are threads that engage the threaded nipple of mechanical coupler 14 and physically support the cartridge 12. A battery 48 supplies electrical power to power supply 10, and can be rechargeable (e.g., via interface/charging port 54).

A memory 50 can store instructions for controller 52, and can be for example, a flash memory, or EEPROM, or other memory type. Memory 50 can represent a single memory or multiple memories. The memory 50 can include any memory or database module and can take the form of volatile or non-volatile memory including, without limitation, magnetic media, optical media, random access memory (RAM), read-only memory (ROM), removable media, or any other suitable component. In general, memory 50 stores operating instructions for controller 52, and can include a database of cartridge types and settings. For example, memory 50 can store a database of operation settings, including heat intensity, duration, and frequency associated with a number of different cartridges. In some implementations, the controller 52 can periodically update this database by communicating with an external system via interface 54. Interface 54 can be a serial interface such as a universal serial bus (USB) type A, C, micro or mini, or other connection. In some implementations, interface 54 serves a dual purpose of providing external communications to power supply 10, as well as electrical power for recharging battery 48.

Controller 52 generally controls power supplied to the contacts 42B and thus to atomizer 36. In some implementations, controller 52 receives additional sensor inputs. For example, controller 52 can receive a signal corresponding to whether a cartridge is installed on power supply 10, and if not, prevent power from being sent to contacts 52B. In another example, controller 52 receives a “puff” signal from one or more sensors in cartridge 12 and uses the puff signal in addition to the cartridge type in order to determine how much power to supply to contacts 42B.

The controller 52 can be enabled or disabled by operation of the biometric sensors 56. When lips are detected at the biometric sensors 56, they can perform a scan and generate a “lip print” that can be compared against a database of authorized lip prints. In some implementations, the memory 50 includes one or more authorized lip prints that can be pre-programmed or manually inserted into the memory. For example, when the user purchases a new vaporizer, the retailer can provide a one-time encryption key to allow the user to load their lip print into the memory 50. In some implementations, the lip print can be recorded using the biometric sensor 56 in a first-time setup, and then additional lip prints or users must be added using a secure passcode or token via the interface 54.

While illustrated as a single controller 52, controller 52 can be multiple components, or in multiple locations. For example, circuitry for operating and controlling the biometric sensors 56 can be located in the cartridge 12, while circuitry for operating and controlling the puff sensor 35 and atomizer 36 can be located in the power supply 10. In general, the controller 52 is operable to interrupt power to the atomizer 36 unless and authorized lip print is detected by the biometric sensors 56. In some implementations, the power supply 10 activates for a limited duration (e.g., 0.5 seconds, 1 second, 5 seconds, etc.) following a successful lip print detection and verification. Lip print verification can include generating a hash based on the detected lip print, and comparing it with a hash of a previously authorized lip print stored in memory 50.

In some implementations, if an unauthorized lip print is detected the device can be temporarily or permanently disabled. For example, if five or more consecutive failed attempts are detected, the device can be disabled, requiring the owner to return to a retail provider to re-activate their device. In some implementations, the device is temporarily disabled (e.g., for 1 hour, 1 day, or 2 days, etc.).

The biometric sensor 56 can prevent device operation in a number of ways. For example, software in the controller 52 can simply not activate the atomizer 36 without the biometric sensor 56 providing an authorized lip print. In another example, a separate controller configured to operate the biometric sensors 56 can independently interrupt power to the atomizer 56, using a switch or a transistor. In these implementations, the switch can default to an open position, isolating the atomizer 36, until an authorized lip print is detected, at which point the switch closes, either for a predetermined period of time, or until the lip contact is no longer detected.

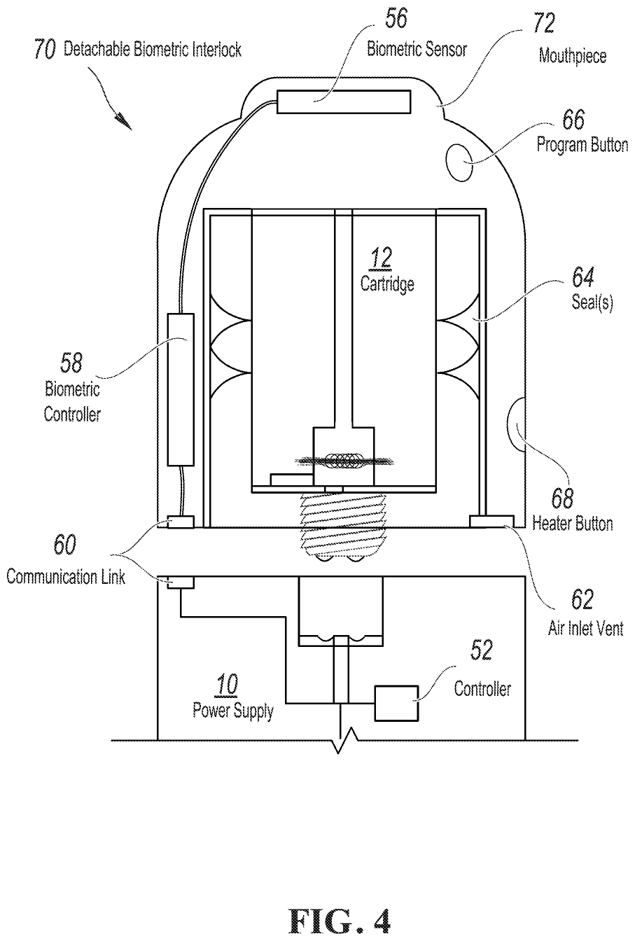

FIG. 4 illustrates an example of personal vaporizer with detachable biometric interlock 70. The detachable biometric interlock 70 is shown in a cover or cap type format, that can magnetically or frictionally engage with the power supply 10 over the cartridge 12. This configuration enables the use of low cost, disposable cartridges 12 while reusing more expensive and complex biometric components such as the biometric sensor 56 and controller 58. The detachable biometric interlock 70 includes one or more seals 64, a biometric sensor 56, controller 58, program button 66, heater button 68, air inlet vent 62, communications link 60, and a mouthpiece 72.

The mouthpiece 72 forms an ergonomic shape for the user to place their lips on, and has a biometric sensor 56 integrated into its surface. The biometric sensor 56 can be an optical sensor, capacitive sensor, ultrasonic sensor, or combination thereof as discussed above with reference to FIG. 3. Biometric sensor 56 is controlled by, or operated by a controller programmed to perform the operations described herein, namely biometric controller 58. In some implementations, the biometric controller 58 includes its own power supply, such as a capacitor, battery and/or other power supply. In general, the biometric controller 58 includes suitable hardware and software for operating the biometric sensor 56 to read lip prints, recording and storing authorized lip prints, determining if a read lip print is an authorized lip print, and if so, activating the personal vaporizer (e.g., by shutting a switch and/or otherwise enabling controller 52 to energize the heating element in cartridge 12).

A communication link 60 can enable the biometric controller 58 to activate or deactivate the controller 52, as well as receive power from the power supply 10. In some implementations the communications link is a serial link (e.g., USB) or other digital link. In some implementations, the communication link 60 is an analog connection, and directly drives one or more circuits in the power supply 10 to activate or deactivate controller 52. In some implementations the communications link 60 features a magnetic coupling with spring loaded or “pogo” pins to enable easy connection and disconnection. In some implementations communication link 60 is a wireless link, using near-field communications (NFC), radio-frequency ID (RFID) communications, and/or other wireless connections.

The air inlet vent 62 can allow air to pass into the lower portion of the detachable biometric interlock 70, then into the cartridge 12 (e.g., via air inlet vent 16 as shown and described in FIG. 3). As the user draws air through the mouthpiece 72, it passes through air inlet vent 62, into the lower portion of detachable biometric interlock 70, where it is drawn through the cartridge 12, into the user's mouth. One or more seals 64 provide a barrier to prevent or reduce air flow past the cartridge 12. The seals 64 can be rubber, neoprene, or other compliant material that can compress or deform to fit around the cartridge 12. As illustrated, detachable biometric interlock 70 includes a pair of ring seals 64 that operate as sleeve seals between the cartridge 12 and the interlock 70. In some implementations, the seals 64 can be an O-ring or compression ring that seals against the top of the cartridge instead of the side. In some implementations, both are used. While two seals 64 are illustrated, a different number of seals is feasible. For example, a single seal, or no seal but instead tight tolerance between the interlock 70 and the cartridge 12 can be used. In another example, more seals (e.g., 3 or 5 or more) can be used.

Optionally, a heater button 68 can be included to allow the user to manually activate the heating element in the personal vaporizer. The heater button 68 can communicate with the power supply portion 10 via communications link 60 and allow the user to energize a vaporizer that doesn't automatically energize (e.g., doesn't include a puff sensor).

A program button 66 can be provided to allow the user to record their lip print as an authorized lip print. In some implementations, the program button 66 is a single use system, which allows the user to program their lips and then becomes non-functional following an initial programming. In some implementations, the program button 66 requires a device reset to be functional, or other security measures.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A system comprising:
a personal vaporizer comprising:
a reservoir configured to hold a fluid to be vaporized;
a puff sensor configured to detect airflow through the personal vaporizer and generate a puff signal;
a heating element configured to atomize the fluid to be vaporized; and
a first controller configured to receive the puff signal and deliver power to the heating element in response to the puff signal; and
a biometric interlock comprising:
a biometric sensor configured to detect a lip print of a user; and
a second controller configured to receive the lip print from the biometric sensor and determine that the lip print is an authorized lip print and in response enable the first controller to deliver power to the heating element.

2. The system of claim 1, wherein the second controller is configured to prevent the first controller from delivering power in response to determining that the lip print is an unauthorized lip print.

3. The system of claim 1, wherein the biometric interlock comprises one or more seals that direct airflow through the personal vaporizer.

4. The system of claim 1, wherein the biometric interlock comprises a battery configured to supply power to the second controller and the biometric sensor.

5. The system of claim 1, wherein the biometric sensor is an optical sensor.

6. The system of claim 1, wherein the biometric interlock comprises a communication link with the personal vaporizer, and wherein the second controller enables the first controller by sending a signal through the communication link.

7. The system of claim 6, wherein the biometric interlock comprises a heater button, and wherein the heater button is configured to send a signal to the first controller using the communication link.

8. The system of claim 1, wherein the biometric interlock comprises a program button that, when depressed, causes the second controller to record a lip print from the biometric sensor as the authorized lip print.

9. A method for activating a personal vaporizer comprising:
sensing contact of a user on a lip sensor;
scanning a lip print of the user with the lip sensor;
determining that the lip print is an authorized lip print and in response:
enabling a controller of the personal vaporizer to deliver power to a heating element of the personal vaporizer.

10. The method of claim 9, wherein the controller delivers power to the heating element in response to a puff signal generated by a puff sensor of the personal vaporizer.

11. The method of claim 9, comprising determining that the lip print is not the authorized lip print or there is no lip print and in response:
preventing the controller from delivering power to the heating element.

12. The method of claim 9, wherein sensing contact of a user is performed with a capacitive sensor of the lip sensor.

13. The method of claim 12, wherein scanning the lip print of the user is performed with the capacitive sensor and an optical sensor of the lip sensor.

14. A system comprising:
a biometric interlock comprising:
a biometric sensor configured to detect a lip print of a user; and
a controller configured to receive the lip print from the biometric sensor enable a personal vaporizer to atomize a fluid to be vaporized.

15. The system of claim 14, wherein the biometric interlock is configured to be coupled to the personal vaporizer and at least partially enclose a cartridge of the personal vaporizer.

16. The system of claim 15, wherein the biometric interlock comprises one or more seals that direct airflow through the personal vaporizer.

17. The system of claim 15, wherein the biometric interlock comprises a communication link with the personal vaporizer, and wherein the controller enables the personal vaporizer by sending a signal through the communication link.

18. The system of claim 14, wherein the biometric interlock magnetically couples with the personal vaporizer.

19. The system of claim 14, wherein the controller is configured to and determine that the lip print is an authorized lip print based on a comparison with a stored lip print that is store in a memory of the personal vaporizer.

20. The system of claim 14, wherein the biometric interlock comprises a battery configured to supply power to the controller and the biometric sensor.
